(19) United States
(12) Patent Application Publication
(10) Pub. No.: US 2003/0042904 A1
(43) Pub. Date: Mar. 6, 2003

(54) Imaging method and a device for processng image data

(76) Inventors: Stefan Wiese, Koln (DE); Nadim Joni Shah, Juelich (DE); Karl Zilles, Koln (DE)

Correspondence Address: Connolly Bove Lodge & Hutz, PO Box 2207, Wilmington, DE, 19899-2207, US

(21) Appl. No.: 10/169,221

(22) PCT Filed: Dec. 20, 2000
(86) PCT No.: PCT/DE00/04561

(30) Foreign Application Priority Data
Dec. 24, 1999 (DE) 199-62-477.1
Dec. 24, 1999 (DE) 199-62-477.1

(51) Int. Cl. G01V 3/00

(52) U.S. Cl. 324/307; 324/309

(57) ABSTRACT

The invention relates to an imaging method. Layer or volume areas are selected by radiating high-frequency pulses and applying a magnetic gradient field which is optionally composed of several individual components. Nuclear magnetic resonances are excited and detected as measured signals in said areas. According to the inventive method, the measured signals are detected in a first acquisition sequence for different echo times. Essentially similar phase positions are selected for different echo times in the acquisition sequence and the acquisition sequence is repeated at least once. The invention also relates to a device for processing image data. Said device comprises at least one memory for storing detected measured data in a kₓ-dimension, a t-dimension and a k_{y}-dimension. The inventive device is characterised in that said device contains a sorter which rearranges the raw data into a sequence, wherein the data of the k_{y}-dimension is arranged upstream in relation to the t-dimension. The transformed measured data is stored in the memory and/or an additional memory in such a way that data of different acquisition sequences is successively arranged in the memory.

The invention relates to an imaging method in which high-frequency pulses are emitted and at least one magnetic gradient field is applied in order to select slice or volume areas in which nuclear magnetic resonances are excited and detected as measuring signals.

The invention also relates to a device for processing image data, whereby the device has at least one memory for storing the detected measuring signals.

The device is, for example, a nuclear resonance tomograph or a computer that is suitable for evaluating data from nuclear magnetic resonance tomography.

The term “computer” is by no means to be understood in a limiting sense. It can be any unit that is suitable for carrying out calculations, for example, a work station, a personal computer, a microcomputer or a circuit that is suitable for performing calculations.

Nuclear magnetic resonance tomography is employed, among other things, to obtain spectroscopic information or image information about a given substance. A combination of nuclear magnetic resonance tomography with the techniques of magnetic resonance imaging (MRI) provides a spatial image of the chemical composition of the substance.

Magnetic resonance imaging is, on the one hand, a tried and true imaging method that is employed clinically worldwide. On the other hand, magnetic resonance imaging constitutes a very important examination tool for industry and research outside the realm of medicine as well. Examples of applications are the inspection of food products, quality control, pre-clinical testing of drugs in the pharmaceutical industry or the examination of geological structures, such as pore size in rock specimens for oil exploration,

The special strength of magnetic resonance imaging lies in the fact that very many parameters have an effect on nuclear magnetic resonance signals. A painstaking and controlled variation of these parameters allows experiments to be performed that are suitable to show the influence of the selected parameter.

Examples of relevant parameters are diffusion processes, probability density distributions of protons or a spin-lattice relaxation time.

In nuclear resonance tomography, atom nuclei having a magnetic momentum are oriented by a magnetic field applied fiom the outside. In this process, the nuclei execute a precession movement having a characteristic angular frequency (Larmor frequency) around the direction of the magnetic field. The Larmor frequency depends on the strength of the magnetic field and on the magnetic properties of the substance, particularly on the gyromagnetic constant γ of the nucleus. The gyromagnetic constant γ is a characteristic quantity for every type of atom. The atom nuclei have a magnetic momentum μ=γ×p wherein p stands for the angular momentum of the nucleus.

In nuclear resonance tomography, a substance or a person to be examined is subjected to a uniform magnetic field. This uniform magnetic field is also called a polarization field B₀ and the axis of the uniform magnetic field is called the z axis. With their characteristic Larmor frequency, the individual magnetic momentums of the spin in the tissue precede around the axis of the uniform magnetic field.

A net magnetization M_{z} is generated in the direction of the polarization field, whereby randomly oriented magnetic field components cancel each other out in the plane perpendicular to this (the x-y plane). After the uniform magnetic field has been applied, an excitation field B₁ is additionally generated. This excitation field B₁ is polarized in the x-y plane and it has a frequency that is as close as possible to the Larmor frequency. As a result, the net magnetization M_{z} can be tilted into the x-y plane so that a transverse magnetization Mₜ is created. The transverse component of the magnetization rotates in the x-y plane with the Larmor frequency.

By varying the time of the excitation field, several temporal sequences of the transverse magnetization Mₜ can be generated In conjunction with an applied gradient field, different slice profiles can be realized.

Particularly in medical research, there is a need to acquire information about anatomical structures, about spatial distributions of substances as well as about brain activity or, in the broader sense, about blood flow or changes in the concentration of deoxyhemoglobin in the organs of animals and humans.

Magnetic resonance spectroscopy (MRS) makes it possible to measure the spatial density distribution of certain chemical components in a material, especially in biological tissue.

Rapid magnetic resonance imaging (MRI), in conjunction with magnetic resonance spectroscopy (MRS), allows an examination of local distributions of metabolic processes. For instance, regional hemodynamics involving changes in the blood volumes and blood states as well as changes in the metabolism can be determined in vivo as a function of brain activity; in this context, see S. Posse et al.: Functional Magnetic Resonance Studies of Brain Activation; Seminars in Clinical Neuropsychiatry, Volume 1, No. 1, 1996; pages 76 to 88.

An experimental study of hemodynamics is presented in “The variability of human BOLD hemodynamic responses” by Aguirre in NeuroImage, 1998, Vol. 8(4), pages 360-369, also in “Neuronal and hemodynamic responses from functional MRI time-series: A commutational model” by J. Rajapakse. F. Kruggel, D. Y. von Cramon, in “Progress in Connectionist-Based Information Systems (ICONIP '97)” by N. Kasabov, R. Kozma, K. Ko, R. O'Shea, G. Coghill, T. Gedeon, Eds., pages 30-34, Springer, Singapore, 1997 and in “Modeling Hemodynamic Response for Analysis of Functional MRI Time-Series by Jagath C. Rajapakse, Frithjof Kruggel, Jose M. Maisog and D. Yves von Cramon; Human Brain Mapping 6: 283-300, 1998 with suggested Gauss und Poisson functions.

NMR imaging methods select slices or volumes that yield a measuring signal under the appropriate emission of high-frequency pulses and under the application of magnetic gradient fields; this measuring signal is digitized and stored in a one-dimensional or multi-dimensional field in a measuring computer.

A one-dimensional or multi-dimensional Fourier transformation then acquires (reconstructs) the desired image information from the raw data collected.

A reconstructed tomograph consists of pixels, and a volume data set consists of voxels. A pixel (picture element) is a two-dimensional picture element, for instance, a square. The image is made up of pixels. A voxel (volume pixel) is a three-dimensional volume element, for instance, a right parallelepiped. The dimensions of a pixel are in the order of magnitude of 1 mm², and those of a voxel are in the order of magnitude of 1 mm³. The geometries and extensions can vary.

Seeing that, for experimental reasons, it is never possible to assume a strictly two-dimensional plane in the case of tomographs, the term voxel is often employed here as well, indicating that the image planes have a certain thickness.

Functional nuclear magnetic resonance makes it possible to detect dynamic changes and thus to observe processes over the course of time.

With functional magnetic resonance imaging (fMRI), images are generated that contain the local changes.

It is also a known procedure to employ functional nuclear magnetic resonance, that is to say, functional nuclear magnetic resonance imaging, to examine neuronal activation.

Neuronal activation is manifested by an increase of the blood flow into activated regions of the brain, whereby a drop occurs in the concentration of deoxyhemoglobin. Deoxyhemoglobin (DOH) is a paramagnetic substance that reduces the magnetic field homogeneity and thus accelerates signal relaxation. Oxyhemoglobin displays a magnetic susceptibility corresponding essentially to the structure of tissue in the brain, so that the magnetic field gradients are very small over a boundary between the blood containing oxyhemoglobin and the tissue. If the DOH concentration decreases because of a brain activity that triggers an increasing blood flow, then the signal relaxation is slowed down in the active regions of the brain. It is primarily the protons of hydrogen in water that are excited. The brain activity can be localized by conducting an examination with functional NMR methods that measure the NMR signal with a time delay (echo time). This is also referred to as susceptibility-sensitive measurement. The biological mechanism of action is known in the literature under the name BOLD effect (Blood Oxygenation Level Dependent effect) and, in susceptibility-sensitive magnetic resonance measurements at a field strength of a static magnetic field of, for example, 1.5 tesla, it leads to increases of up to about 5% in the image brightness in activated regions of the brain. Instead of the endogenous contrast agent DOH, other contrast agents that cause a change in the susceptibility can also be used.

It is advantageous to suppress the lipid signals. Preference is given to using a frequency-selective lipid presaturation.

The imaging method is preferably a spectroscopic echo-planar imaging method, especially a repeated two-dimensional echo-planar imaging method, consisting of the repeated application of two-dimensional echo-planar image encoding.

Spatial encoding takes place within the shortest possible period of time, which can be repeated multiple times during a signal drop, preferably amounting to 20 ms to 100 ms.

The multiple repetition of the echo-planar encoding serves to depict a course of the signal drop in the sequence of reconstructed individual images during a signal drop.

The relaxation time T₂* is quantified by means of several images that are taken at different echo times. At a given matrix size, the number of images is limited as a function of the properties of the measuring equipment and the value of T₂*. Therefore, in order to generate quantitative images, the data has to be adapted on the basis of a limited number of data points that are possibly noise-infested.

The invention is based on the objective of improving the resolution of the images taken and reducing the effect of interfering signals.

This objective is achieved according to the invention in that the measuring signals are detected for different echo times in a first acquisition sequence, in that essentially identical phase positions are selected for different echo times in the acquisition sequence and in that the acquisition sequence is repeated at least once.

It is advantageous for the same phase position to be selected for all of the echo times of one acquisition sequence.

Moreover, it is advantageous for such measuring signals associated with a selected echo time to be combined into one detection range.

Another improvement of the determination of the value of the relaxation time T₂* is achieved in that the detection range essentially corresponds to a plane in a kₓ, t, k_{z}) space.

Moreover, it is advantageous for signals associated with at least two different echo times to be combined for a correction of geometric interferences.

The invention also provides for configuring a device for processing image data, said device having at least one memory for storing the detected measured data in a kₓ dimension, in a t dimension and in a k_{y} dimension in such a way that the device comprises a sorter that rearranges the raw data in an order in which the data of the k_{y} dimension is arranged before the t dimension, and in that the transformed measuring signals are stored in the memory and/or in another memory in such a way that data from different acquisition sequences is arranged consecutively in the memory.

A Fourier transformation is a suitable method for obtaining images. A fast Fourier transformation (FFT) lends itself for increasing the speed.

The echo planar imaging according to the invention is very fast, as a result of which it is particularly well-suited for detecting images of spectroscopic properties of the entire brain, where otherwise, much longer acquisition times are needed. Thus, the invention especially allows fast spectroscopic imaging. At a field strength, for instance, of 1.5 T, the time needed to image one slice is about 100 ms which, considering a practical coverage of the entire brain, for example, in 32 slices, calls for a total imaging time of about 4 seconds. The hemodynamic response curve, in contrast, should be detected in a grid time that is sufficient to perform a good data adaptation.

A possible method for solving this problem is a repetition of the measurements several times at incrementally staggered time shifts, which leads to results that correspond to measurements having a smaller grid time. This method entails the drawback that repeating the measurements several times prolongs the overall measuring time and also that any instabilities on the part of the scanner used for the nuclear magnetic resonance test influences the measurement.

With the keyhole imaging method, a signal in the reciprocal k-space is separated into two different areas, namely, first into a central area having small spatial frequencies that is responsible for providing contrast in the generated image, and secondly, into outer regions of the k-space that have high spatial frequencies and that contain essential information about the spatial resolution. In the case of several consecutive measurements in which contrast changes are being examined, it is sensible for only the central area of the k-space to serve as the basis for the examination.

Additional advantages, special features and practical refinements of the invention can be found in the subordinate claims and in the presentation below of a preferred embodiment making reference to the drawings.

The drawing shows an excitation sequence that is suitable for performing the method according to the invention.

The drawings show the following:

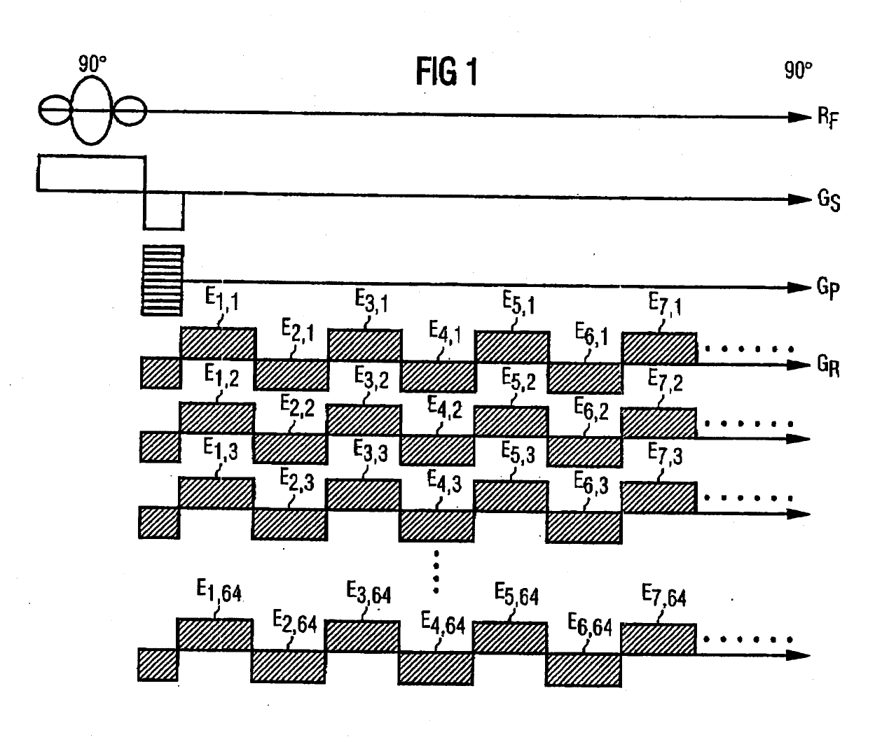

FIG. 1—an excitation sequence that is suitable for performing the method according to the invention and

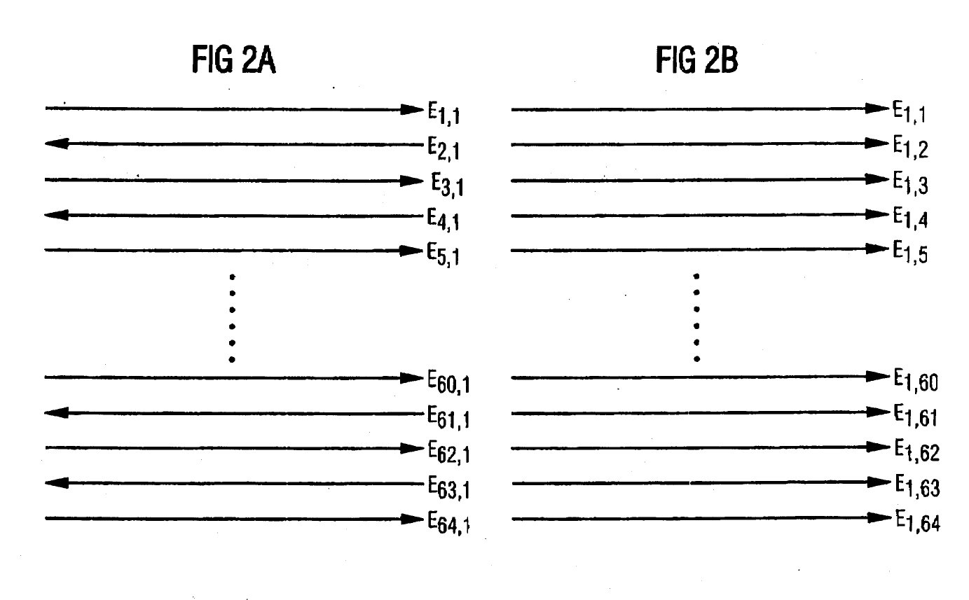

FIG. 2—a schematic representation of a detection of a spatial frequency space (k-space).

Below, it will be shown how more reliable values for T₂* are obtained through suitable phase encoding.

For this purpose, a good data adaptation is advantageous since it markedly reduces the influence of measuring errors, thus rendering possible the detection of more subtle activations that result from complicated paradigms

The method shown in FIG. 1 shows an acquisition method that makes it possible to acquire date for a subsequent determination of T₂* values.

This method is based on the use of the EPSI technique as described, for example, in the article by P. Mansfield: Magn. Reson. Med., 1, page 370, 1984. However, it has a different phase encoding.

In the use according to the invention of the same phase encoding for all echo signals in one acquisition sequence and subsequent repetition of the acquisition sequence n times, it is possible to rearrange the data after the measurement. As a result, images are created that contain echo signals that were taken at the same echo time T_{E} and contain, for example, either all of the even-numbered echo signals or all of the odd-numbered echo signals.

Looking at the simple case of a “single section” application with a matrix of N×N, then N repetitions are needed.

Regarding the case shown in FIG. 1, this means that, instead of the construction of an image on the basis of echo signals [GE (1,1), GE (2,1), GE (3,1), . . . GE (64,1)], an image is constructed on the basis of echo signals [GE (1,1), GE (2,1), GE (3,1), . . . GE (64,1)].

The x-coordinate likewise designates T_{E}. All of the echo signals in the second scheme contain the same echo time T_{E}.

A person skilled in the art can easily generalize the conversion method for other echo signals and for other areas to be examined.

The acquisition scheme described above encompasses the following very important advantages:

1. Since all echoes/reproductions in the k-space of a given image are either consistently even-numbered or odd-numbered, no ghost images occur among the reconstructed images.

2. The rearrangement of the echo signals ensures that only the echo signals associated with the detected echo time T_{E} are combined in a given plane of the k-space. No convolution of the signals with a T₂* drop function occurs. This can be seen, for example, during the traversing of the k-space from the outside lines that lie far in the positive area, through the center and to the lines that lie far in the negative area. The consequence is that the spatial resolution does not decrease as is the case in a normal EPI.

3. The central measuring signals, which are encoded with a zero phase, can be used for another, optionally subsequent, phase correction. Thus, no preliminary tests are needed in order to carry out a data correction.

4. The data from two or more echo signals can be used to draw up a projection map for a subsequent correction of geometric distortions in the images.

In magnetic resonance spectroscopy (MRS), sectional images are generated with a pre-defined grid of N_{Y} lines and N_{X} columns (CSI=Chemical Shift Imaging). The preferred process steps are presented below:

1) First of all, the resonant nuclear spins located in the volume of interest of the specimen and polarized in the presence of an external magnetic field B₀=B₀e_{Z} are excited by means of suitable RF irradiation (RF—radio frequency) in order to generate a signal. The magnetization M, which is altogether formed by the nuclear spin, then has a measurable component M_{XY} that is orthogonal to B₀ and that precedes with the angular velocity ω=−γB₀.

2) Subsequently, the signal is spatially encoded through the brief application of magnetic field gradients G=ΔB₀/Δr, whose purpose is to vary the external magnetic field linearly with the location r. As a result, the resonant nuclear spins precede for a brief time with an additional angular frequency Δω(r)=−γGr and emit a phase-modulated MR signal after the gradient G has been switched off.

3) This modulated MR signal is then scanned for a sufficiently long time, that is to say, about as long as necessary for M_{XY} to become completely dephased, and at sufficiently short time intervals.

4) Steps 2 and 3 are repeated as many times as the sectional image is supposed to have grid points, in other words, (N_{Y}×N_{X}) times in the case at hand. With each repetition, the gradient strength G or the time duration of the application is varied, as is needed for a correct spatial encoding.

5) A digital computer is then employed to flier process the data points thus acquired and ultimately to compute the sectional images.

The execution, however, can also be completed with just some of the steps described. For instance, the second and fourth steps can be dispensed with if spatially resolved encoding is not needed. This results in spatially resolved frequency spectra on the basis of which the relative concentration of individual chemical components can be computed. These can be distinguished because the effective magnetic field at the location of a nucleus and thus also its precession frequency are a function of its parent molecule, which shields the external magnetic field to a greater or lesser extent.

When it comes to the examination of biological tissue, it is most advantageous to select protons as the resonant nuclei. In this context, the very strong signals of the water and of the lipids at concentrations in the double-digit molar range are to be suppressed so that the metabolic products (metabolites) of interest can be detected in the millimolar range. The signal of the water protons is relatively easy to suppress since it is present virtually isolated in the frequency spectrum, as a result of which it can be eliminated by appropriate RF irradiation. There are combinations of CHESS pulses (CHESS=CHEmical Shift Selective) with which suppression factors of up to 3000 can be attained.

In order to reduce the measuring duration by more than one order of magnitude in spatially resolved spectroscopy, the phase encoding can be partially combined with the read-out of the MR signal. This technique, known as echo-planar spectroscopic imaging (EPSI), is considered to be difficult to apply to clinical nuclear spin tomographs and it makes additional high requirements of the quality of the hardware components, especially of the homogeneity of the main magnetic field B₀. This is why the EPSI method is not yet very widespread, although this could change with the next generation of nuclear spin tomographs. The advantage lies in a measuring duration that is shortened by the factor N_{X}.

A PRESS excitation serves for the targeted excitation of a specimen volume that is defined as a sectional right parallelepiped consisting of three orthogonal slices. The nuclear spins within this target volume generate the MR signal from a double spin echo, corresponding to the three slice-selective RF pulses from which PRESS is structured:

90°−t₁−180°−t₁−spin echo−t₂−180°−t₂−measurement, whereby preferably: t₂≧t₁.

Spins that lie outside of the target volume but that have been exposed to the 90° pulse at most undergo one more 180° pulse and are otherwise dephased by the necessary slice selection gradients. Spins that have not been exposed to a 90° angle do not lead to a measurable signal, even when one or both have been exposed to 180° pulses.

It is necessary to avoid any unsharpness of the slice profiles of the 180° pulses, since this could result in undesired MR signals from outside of the volume of interest. One possibility for this is a dephasing of the signal (crushing). The crushing can be achieved most easily in that the slice selection gradients of the two 180° pulses last longer than would otherwise be necessary. The slice selection gradients, however, still have to be arranged symmetrically around the 180° pulses so as not to impair the spin rephasing.

Another improvement can be achieved in that the crushing is cared out with much stronger gradients which are orthogonal to the slice selection gradients. In this manner, a possible rephasing of undesired stimulated echoes is ruled out.

Subsequently, a signal excitation, especially a PRESS signal excitation, is read out by means of spatial-spectral encoding EPSI). In a (k, t) diagram, an entire k_{X}, t) slice is acquired for each PRESS excitation. Which slice this is is selected directly after the PRESS excitation by means of a phase encoding gradient in the k_{Y} direction. Therefore, for the measurement of a k_{X}, t) slice, the signal only has to be excited once, in contrast to conventional spectroscopic imaging, where N_{X} signal excitations would be necessary. After this EPSI read-out is complete, the measured data is reinterpreted in a suitable manner, namely, as (k_{X}, k_{Y}) slices at different points in time t. Formally, this is done by rearranging the measured data. Then the data can be further processed with the usual methods of conventional spectroscopic imaging.

The coordinates (k_{X}, k_{Y}) are only shown by way of example. The person skilled in the art can select suitable (k_{X}, k_{Y}) for each examination.

Below, it will be shown how a BOLD effect can be studied using the invention. For this purpose, measurements were carried out in test subjects using a Vision 1.5 T full-body scanner. The examinations show the reactions of test subjects to flashing red light at a frequency of about 8 Hz. In order to increase the sensitivity of the measuring device in the occipital cortex, where the vision center is located, a flexible quadrature surface coil was used. This test arrangement was used to carry out the following measurements:

100 EPI scans with a (10-[5-10]⁶) paradigm, 10 base images each (LED mask switched off) and 5 activation images (LED mask switched on):

The paradigm repetition time between the individual EPI scans amounts to T_{PR}=T_{R}=3s, the echo time is selected as T_{E}=66 ms. The spatial resolution in each slice is 6.25×6.25 mm², corresponding to a 32×32 image mat and a FOV (field of view) of 200×200 mm². The total of four spatial slices each have a thickness of 10 mm, with a distance of 1 mm between two slices. Due to the long T_{R}, a flip angle of 90° can be selected. The EPI image reconstruction is preferably done on line by the MR scanner.

It is especially advantageous that the EPI scans pass through a spatial frequency space to be examined having the fewest possible changes in the signs of the scanning directions used.

Such a preferred traversing of the spatial frequency space is shown below with reference to FIG. 2 by way of an example.

A partial image (a) of FIG. 2 shows a known detection of the spatial frequency space by means of echo-planar spectroscopic imaging (EPI).

Here, echo signals E_{x,y} are shown, whereby the x-coordinates indicate a detection time.

The individual echo signals are detected at different points in time here so that echo signals at a later point in time are impaired by tile T₂* drop.

A partial image (b) of FIG. 2 shows a detection according to the invention of the spatial frequency space by means of rearranged echo-planar spectroscopic imaging.

The sign of the detection direction is changed between the even-numbered and the odd-numbered echo signals.

Here, echo signals E_{x,y} are likewise shown, whereby the x-coordinates once again indicate the detection time.

Here, all of the echo signals E_{x,y} are detected with the same echo time, thus avoiding an impudent due to the T₂* drop.

Moreover, this avoids the need for a change in the sign of the detection direction between the even-numbered and the odd-numbered echo signals.

A conventional traveling of the spatial frequency space is possible, but the rearrangement entails several considerable advantages. The advantages are especially a high spatial resolution and a gain in speed.

Below, it will be shown how a rearrangement of raw data can be carried out in a preferred manner.

A rearrangement of the raw data is preferably carried out in such a way that data previously present in an order kₓ, t, k_{y} is rearranged so that it acquires the order kₓ, k_{y}, t.

Here, kₓ designates the dimension in which the measurement is first made. In the original data, this is followed by a time dimension t. In the original data, the time dimension t is followed by the additional space dimension k_{y}. The rearrangement of the raw data can be carried out in different ways.

An especially advantageous arrangement of the raw data is made by a suitable data processing routine. The data processing routine processes the original data records in such a way that the data is transferred into the desired format.

A program written in computer language C that brings about a desired rearrangement of the measured data is given below.

| | | | |
|---|---|---|---|
| #define | MAX_DIMS 10 | /*10 maximum number of dimensions | */ |
| long | Dim[MAX_DIMS], | /* size of the dimensions | */ |
| | NumberDims; | /* number of dimensions used | */ |
| unsigned char | *Active, | /* positions of data records used | */ |
| | *Passive | /*A 2^{nd} buffer size | |

| * ============================== | | * |
|---|---|---|
| * | swap two dimensions of the data set. | * |
| * -------------------------------------------------- | | * |
| * | swap0 = 1^{st} swap dimension | * |
| * | swap1 = 2^{nd} swap dimension | * |

| | |
|---|---|
| * ============================== | * |

void SwapDims (int swap0, int swap1) {

| long ix[MAX_DIMS]={0}, six, dix; | |
|---|---|
| int dd[MAX_DIMS], d; | |
| unsigned char *swapptr; | |
| if (swap0=swap1) return; | |
| for (d=0; d<NumberDims; d++) dd[d]= d; | |
| d= dd[swap1]; dd[swap1]= dd[swap0]; dd[swap0]= d; | |
| six=0; | |
| do | {dix=0; for (d=NumberDims−1; d>=0; d−) dix=dix* |
| | Dim[dd[d]]+ix[dd[d]]; Passive[dix]=Active[six++]; |
| | d=0; while (d<NumberDims && ++ix[d]==Dim[d]) |
| | ix[d++]=0; |

| } while (d!=NumberDims); | | |
|---|---|---|
| dix | = | Dim[swap1]; |
| Dim[swap1] | = | Dim[swap0]; |
| Dim[swap0] | = | dix; |
| swapptr | = | Active; |
| Active | = | Passive; |
| Passive | = | swapptr; } |

Patent claims

1. an imaging method in which high-frequency pulses are emitted and at least one magnetic gradient field is applied in order to select slice or volume areas in which nuclear magnetic resonances are excited and detected as measuring signals, characterized in that the measuring signals are detected for different echo times in a first acquisition sequence, in that essentially identical phase positions are selected for different echo times in the acquisition sequence and in that the acquisition sequence is repeated at least once.

2. The method according to claim 1, characterized In that the same phase position is selected for all of the echo times of one acquisition sequence.

3. The method according to claim 1 and/or claim 2, characterized in that measuring signals associated with a selected echo time are combined into one detection range.

4. The method according to claim 3, characterized in that the detection range essentially corresponds to a plane in a (k, t) space.

5. The method according to one or more of claims 1 to 4, characterized in that signals associated with at least two different echo times are combined for a correction of geometric interferences.

6. A device for processing image data, whereby the device has at least one memory for storing the detected measured data in a kₓ dimension, in a t dimension and in a k_{y} dimension, characterized in that the device comprises a sorter that rearranges the raw data in an order in which the data of the k_{y} dimension is arranged before the t dimension, and in that the transformed measuring signals are stored in the memory and/or in another memory in such a way that data from different acquisition sequences is arranged consecutively in the memory.
